(19) United States
(12) Patent Application Publication
(10) Pub. No.: US 2025/0337557 A1
(43) Pub. Date: Oct. 30, 2025

(54) SIGNAL QUALITY ANALYSIS BASED ON DIGITAL CORRELATION

(71) Applicant: Microchip Technology Incorporated, Chandler, AZ (US)

(72) Inventors: Jiachi Yu, Foshan (CN); Venkatraman Iyer, Austin, TX (US); Kevin Yang, Shenzhen (CN); Thor Lei Xia, Shenzhen (CN); Hongming An, San Diego, CA (US)

(21) Appl. No.: 19/223,772

(22) Filed: May 30, 2025

Related U.S. Application Data
(63) Continuation-in-part of application No. PCT/CN2024/090335, filed on Apr. 28, 2024.

(51) Int. Cl. H04L 7/02

(52) U.S. Cl. CPC H04L 7/02

(57) ABSTRACT

A method may include correlating a digital received signal with a selected data pattern, the selected data pattern comprising one of: a predetermined data pattern or a recovered data pattern; and providing an indication of quality that is proportional to a determined correlation between the digital received signal and the selected data pattern.

### CROSS-REFERENCE TO RELATED APPLICATIONS

This application is a continuation-in-part of, and claims priority under 35 U.S.C. § 120 and 35 U.S.C. § 365(c) to, International Patent Application No. PCT/CN2024/090335, filed Apr. 28, 2024, the disclosure of which is incorporated herein by this reference in its entirety.

### FIELD

One or more examples relate to signal quality analysis based on digital correlation.

### BACKGROUND

Signal quality information may be used in a variety of operational contexts such as Ethernet.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting an apparatus to monitor signal quality, in accordance with one or more examples.

FIG. 2 is a block diagram of an apparatus to analyze signal quality, in accordance with one or more examples.

FIG. 3 is a block diagram of an apparatus to correlate a digital receive signal with a selected pattern, in accordance with one or more examples.

FIG. 4 is a block diagram of an apparatus to detect the presence of scrambled data in a digital received signal, in accordance with one or more examples.

FIG. 5 illustrates an example process for generating an indication of signal quality in accordance with one or more examples.

FIG. 6 illustrates an example process for choosing a selected data pattern, in accordance with one or more examples.

FIG. 7 illustrates an example process for choosing a selected data pattern, in accordance with one or more examples.

FIG. 8 illustrates an example process for determining a signal quality based on a correlation, in accordance with one or more examples.

FIG. 9 illustrates an example process for using an FIR filter to generate a correlation signal, in accordance with one or more examples.

FIG. 10 illustrates an example process for reducing a timing mismatch between a selected data pattern and a digital received signal, in accordance with one or more examples.

FIG. 11 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application-Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the terms “assert,” “de-assert” and derivatives thereof used in reference to a pin, means, respectively, to assert or de-assert a signal associated with the pin (e.g., a signal specifically assigned to the pin or a signal to which the pin is specifically assigned, without limitation). The term “pin,” as used herein, is not meant to be limited to any particular type of physical structure, and may include, without limitation, gull-wing or J-lead terminals, solder balls, or lands, or any other connection point.

An eye diagram provides a means to assess the overall quality and consistency of a digital signal and, optionally, performance of a digital transmission system or portion thereof. An eye diagram is formed by superimposing one or more segments of the waveform of a digital signal on top of each other. The segments are aligned such that the bit transitions occur at the same points in time on the horizontal axis. This overlapping creates a composite picture. An eye diagram provides a visual indication of signal quality and optionally performance of a digital transmission system. Aspects include the width of the eye opening (horizontal dimension or span), which indicates the time period over which the signal can be reliably sampled, and the height of the eye opening (vertical dimension or span), which shows the margin between logic levels.

A wide-open eye is indicative of a clear distinction between ones and zeros in a digital signal, implying good signal quality. Conversely, a closed or distorted eye indicates poor signal quality, which may be due to noise, distortion, jitter, or other signal impairments. The “eye width” is the horizontal span at the center of the eye diagram, and it represents the time interval where the signal is most stable and less subject to jitter. Measuring eye width provides an indication of the signal's quality. An eye opening having a wider span is indicative of a higher signal quality that is less suspectable to jitter than an eye opening having a narrower span, which is indicative of a lower signal quality that is more susceptible to jitter.

It is appreciated that an eye width measurement performed digitally may be used to determine signal quality indications.

A “data pattern” is a sequence of symbols. Respective symbols of a data pattern may represent one or more bits of data, e.g., one bit of data (e.g., Pulse-Amplitude Modulation (PAM) 2 symbol, a Binary Phase Shift Keying (Binary PSK or BPSK) symbol, a Binary Frequency Shift Keying (Binary FSK or BFSK) symbol, without limitation), two bits of data (e.g., a PAM-4 symbol, a Quadrature PSK (QPSK) symbol, a 4-FSK symbol, without limitation), three bits of data (e.g., a PAM-8 symbol, without limitation), or four bits of data (e.g., 16-QAM (Quadrature Amplitude Modulation) symbol, without limitation), without limitation.

In digital communication, noise, channel impairments, and inter-symbol interference (ISI) may distort a received signal. Signal quality is sometimes monitored to determine information about distortions, if any, present in a received signal.

A received signal is correlated with data symbols recovered from the received signal, and the correlation is utilized to determine an indication of signal quality. Correlation based signal quality monitoring is more sensitive to some kinds of interference, such as noise caused by direct power injection (DPI).

One or more examples relate, generally, to signal quality monitoring. A digital received (RX) signal is correlated with a selected data pattern. The selected data pattern may include one of a predetermined data pattern or a recovered data pattern. The recovered data pattern may be recovered from the digital RX signal. The predetermined data pattern may be stored and utilized as discussed herein. An indication of quality is provided that is based on (e.g., is proportional to, without limitation) a determined correlation between the sampled data pattern and the selected data pattern.

In one or more examples, the recovered data pattern may be utilized for a portion of the digital RX signal that is a non-predetermined portion and not utilized for a portion of the digital RX signal that is predetermined portion. In one or more examples, a non-predetermined portion may, or may not, be scrambled. In some examples, a recovered data pattern may be utilized for a non-predetermined portion of the digital RX signal irrespective of whether the non-predetermined portion of the digital RX signal is scrambled or processed. In other examples, a recovered data pattern may be utilized for a non-predetermined portion of the digital RX signal solely if it is scrambled. As a non-limiting example, the non-predetermined portion may be raw frame data that is not scrambled or processed but that does not include a known (e.g., predetermined) sequence of symbols (e.g., known symbols of a known frame structure, as discussed below, without limitation) such as payload, without limitation. As used herein, the term “scrambled” is intended to encompass obfuscation of a signal, randomization of a signal, pseudo-randomization of a signal, encryption of a signal (e.g., to enhance security, without limitation), compression of a signal (e.g., to reduce bandwidth, without limitation), rearranging data in a non-sequential order (e.g., to enhance signal integrity, without limitation). While various examples discussed below refer to scrambled/unscrambled portions, the examples are also intended to encompass non-predetermined portions.

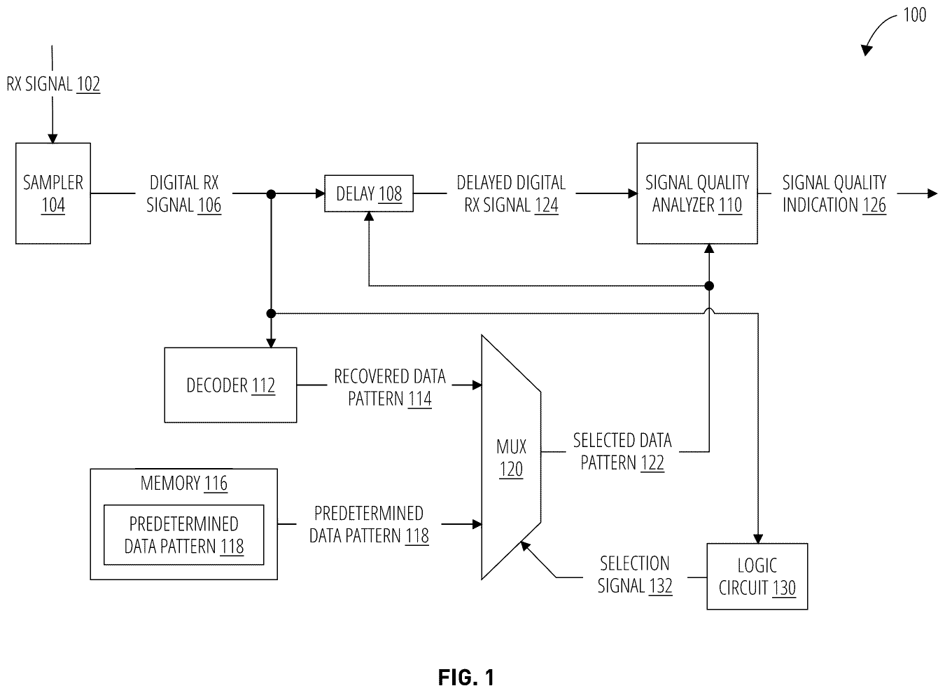

FIG. 1 is a block diagram depicting an apparatus 100 to monitor signal quality, in accordance with one or more examples.

Apparatus 100 includes sampler 104, delay 108, signal quality analyzer 110, decoder 112, memory 116, multiplexer 120 (“MUX 120”), and logic circuit 130. In one or more examples, apparatus 100 is a digital circuit.

Apparatus 100 generates an indication of signal quality 126 at least partially based on a received signal 102 (“RX signal 102”). Generally, apparatus 100 correlates RX signal 102 with a selected data pattern 122 that is based on either a predetermined data pattern or a recovered data pattern, as discussed below. Having the option to use the predetermined data pattern or the recovered data pattern allows apparatus 100 to process unscrambled portions of RX signal 102 using the predetermined data pattern, and to process scrambled portions of RX signal 102 using the recovered data pattern, as discussed below.

RX signal 102 is a digital signal received via, as a non-limiting example, a digital transmission system coupled to, or including, apparatus 100. Signal quality indication 126 may be utilized as an indication of quality of RX signal 102, a digital transmission system, a channel, or a combination thereof, without limitation.

In one or more examples, such a digital transmission system may be based on 10BASE-T1S, which is a network technology specified in IEEE 802.3cg™. IEEE 802.3cg specifies physical layer (PHY) behavior for Physical Layer Collision Avoidance (PLCA). The Open Alliance (OA) Tech Committee (TC) 14 adds other specifications for automotive use of a PHY. According to OA's TC 14, data may be modulated utilizing PAM-2 symbols, and symbols may be encoded utilizing Differential Manchester Encoding. OA's TC 14 specifies advanced diagnostics including signal quality indication. Other networking topologies do not exceed the scope of this disclosure.

Sampler 104 is an M times sampler, where M is an integer greater than 0, i.e., for each symbol M samples are taken. Sampler 104 digitizes RX signal 102 to generate a digital RX signal 106, which is the samples of RX signal 102 generated by sampler 104. In one or more examples, sampler 104 oversamples RX signal 102 to generate digital RX signal 106. Oversampling is sampling a signal at a frequency higher than the Nyquist rate. The Nyquist rate, which is twice the highest frequency present in a signal (according to the Nyquist-Shannon sampling theorem), is the lowest sampling rate required to accurately reconstruct a signal from its samples without aliasing.

Decoder 112 is a digital circuit that receives and interprets digital RX signal 106 according to a modulation scheme (e.g., QAM, PSK, FSK, without limitation) to determine the symbols of RX signal 102, and to recover the data pattern having those determined symbols, i.e., recovered data pattern 114. In one or more examples, decoder 112 may optionally apply error correction in its determination of recovered data pattern 114. Notably, the symbols in recovered data pattern 114 are based on the same modulation scheme as symbols of digital RX signal 106 and are encoded according to the same encoding scheme. Notably, in some instances the greater the number of errors corrected by decoder 112 in a portion of digital RX signal 106, the lower the signal quality indicated by signal quality indication 126, because there will be differences between the corrected and recovered data pattern in recovered data pattern 114 and the data pattern of digital RX signal 106.

Memory 116 stores predetermined data pattern 118. In one or more examples, predetermined data pattern 118 is settable and storable, e.g., by a user, without limitation. Utilizing a predetermined data pattern may be efficient in that the signal quality analyzer 110 does not have to wait for decoder 112 to recover a data pattern from RX signal 102. Further, if noise affects the decoder 112, distortion may be detected utilizing predetermined data pattern 118. Further still, predetermined data pattern 118 may be set to meet specific quality requirements.

In one or more examples, the sequence of symbols in the predetermined data pattern 118 may correspond to a known sequence of symbols for a known frame structure. As a non-limiting example, an Ethernet frame includes a first portion with known symbols for one or more of: commit, beacons, and start-of-stream delimiter (SSD) which are typically not scrambled. Predetermined data pattern 118 may correspond to these known sequence of symbols, including a specific type of modulation scheme (e.g., PAM, QAM, without limitation) and encoding scheme (e.g., DME, without limitation).

Multiplexer 120 receives recovered data pattern 114 at a first input and receives predetermined data pattern 118 at a second input, selects one of the first and second inputs in response to a value of selection signal 132, and provides the selected one of recovered data pattern 114 or predetermined data pattern 118 at its output as selected data pattern 122.

Logic circuit 130 sets selection signal 132 to control selection and provision of recovered data pattern 114 or predetermined data pattern 118 at multiplexer 120. In one or more examples, if logic circuit 130 determines that scrambled data is present in digital RX signal 106 (or a portion thereof), then logic circuit 130 sets selection signal 132 to a first value to cause multiplexer 120 to select the first input associated with recovered data pattern 114. If logic circuit 130 determines that unscrambled data is present in digital RX signal 106 (or a portion thereof), then logic circuit 130 sets selection signal 132 to a second value (different than the first value) to cause multiplexer 120 to select the second input associated with predetermined data pattern 118.

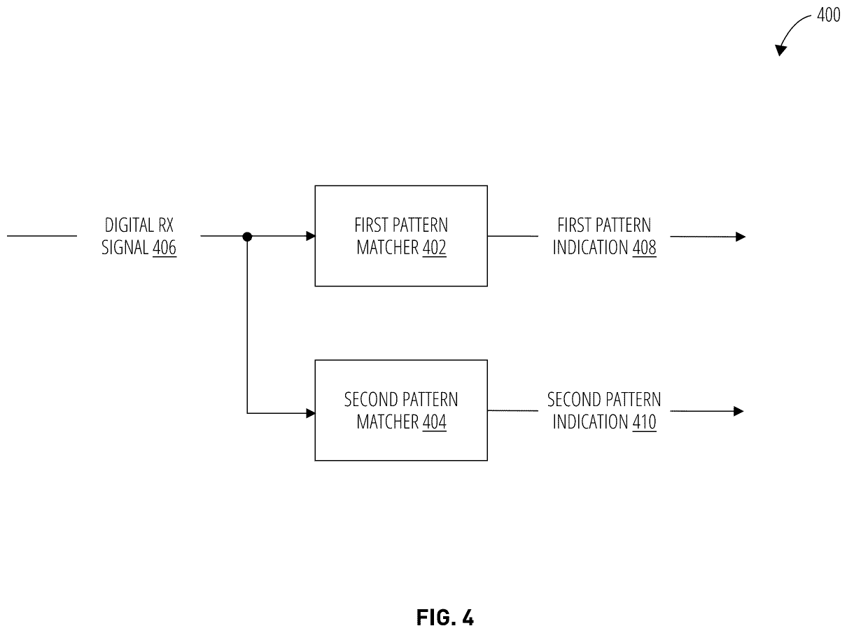

In one or more examples, logic circuit 130 may include one or more pattern matchers (pattern matchers not depicted by FIG. 1 but shown in FIG. 4) to detect symbols in digital RX signal 106 that indicate scrambled data and unscrambled data. As a non-limiting example, IEEE 802.3cg specifies a frame structure for an Ethernet Frame. In IEEE 802.3cg, an Ethernet frame starts with unscrambled commit symbols, beacon symbols, and SSD symbols, followed by scrambled preamble symbols and payload symbols. The one or more pattern matchers may process RX signal 102 for such symbols and generate an indication in response to detecting the symbols. The one or more pattern matchers may assert a pattern indication to indicate a portion of RX signal 102 that corresponds to a known unscrambled data pattern that is detected, and may not assert the pattern indication when an unknown scrambled data pattern is detected.

Logic circuit 130 sets selection signal 132 to cause selection of the recovered data pattern 114 in response to the presence of scrambled data (e.g., a pattern matcher output changing from a first value that indicates unscrambled data to a second value that indicates scrambled data, without limitation). Logic circuit 130 sets selection signal 132 to cause selection of the predetermined data pattern 118 in response to presence of unscrambled data (e.g., a pattern matcher output changing from the second value that indicates scrambled data to the first value that indicates unscrambled data, without limitation).

Delay 108 reduces timing difference between the digital RX signal 106 and selected data pattern 122 by delaying digital RX signal 106 to generate delayed digital RX signal 124. In one or more examples, difference may be caused by timing difference in the signal path between sampler 104 and signal quality analyzer 110 that includes decoder 112 and MUX 120, and the signal path between sampler 104 and signal quality analyzer 110 that includes delay 108. In one or more examples, delay 108 or timing management more generally, may be included in signal quality analyzer 110.

In one or more examples, decoder 112, multiplexer 120 and logic circuit 130 have a known fixed delay, and delay 108 may be set to implement the same duration of the known fixed delay.

Signal quality analyzer 110 receives delayed digital RX signal 124 and selected data pattern 122, determines signal quality (as discussed below) at least partially based on delayed digital RX signal 124 and selected data pattern 122, and generates signal quality indication 126 to indicate the determined signal quality.

In one or more examples, signal quality indication 126 is at least partially based on (e.g., proportional to, without limitation) correlation between digital RX signal and a selected data pattern.

In one or more examples, logic circuit 130 may determine one or more portions of digital RX signal 106 to be scrambled or unscrambled data, and may store information about digital RX signal 106 and which portions are scrambled or unscrambled. The stored information identifying which portions of digital RX signal 106 are scrambled or unscrambled may be used to correlate a recovered version of digital RX signal 106 (or a portion thereof) with the portion of digital RX signal 106 identified as scrambled. In one or more examples, the information identifying portions of digital RX signal 106 that are scrambled or unscrambled, the digital RX signal 106, and the recovered version of the digital RX signal 106, may be stored and then correlated and analyzed later in time.

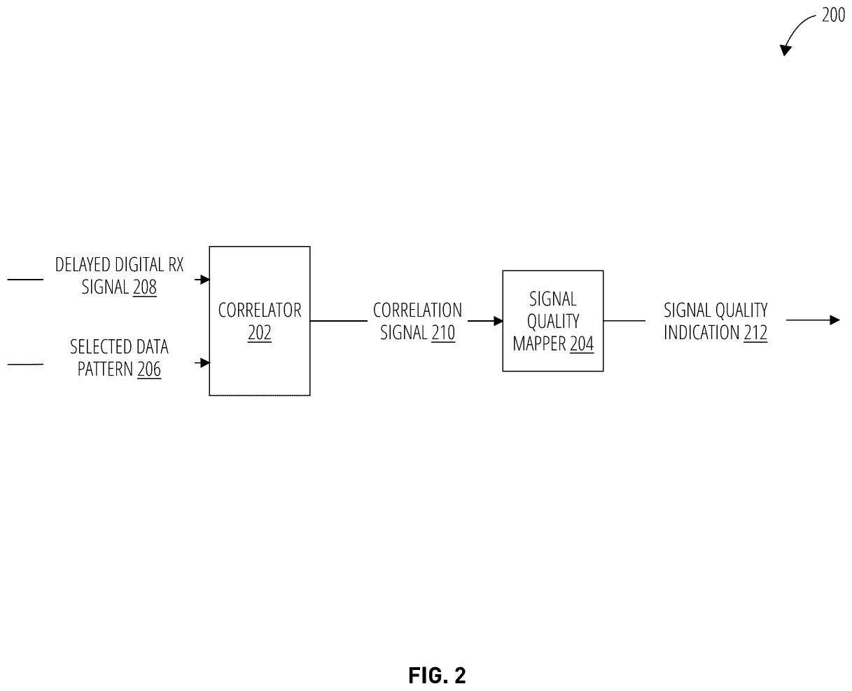

FIG. 2 is a block diagram of an apparatus 200 to analyze signal quality in accordance with one or more examples. Apparatus 200 is a non-limiting example of signal quality analyzer 110 of FIG. 1 and so may also be referred to as a “signal quality analyzer 200.”

Apparatus 200 includes correlator 202 and signal quality mapper 204. Generally speaking, apparatus 200 utilizes correlation between selected data pattern 206 and delayed digital RX signal 208 to determine signal quality.

Correlator 202 receives selected data pattern 206, which selected data pattern 206 may be an example of selected data pattern 122 of FIG. 1 and delayed digital RX signal 208, and generates correlation signal 210 at least partially based thereon. The magnitude of correlation signal 210 is proportional to a degree of similarity between selected data pattern 206 and delayed digital RX signal 208 of a unit interval (e.g., a predetermined time interval or spatial interval, without limitation), as determined by correlator 202. Correlator 202 may utilize any suitable technique to determine correlation (e.g., cross-correlation, without limitation) as long as correlation signal 210 changes in a reliably predictable manner as the degree of similarity between selected data pattern 206 and delayed digital RX signal 208 changes. As a non-limiting example, the magnitude of correlation signal 210 may increase with increasing degree of correlation between selected data pattern 206 and delayed digital RX signal 208, and decrease with decreasing degree of correlation between selected data pattern 206 and delayed digital RX signal 208.

In one or more examples where correlator 202 utilizes cross-correlation, correlator 202 shifts one signal over the other, calculates the product of overlapping elements, and sums the products for each shift. The peak value of the cross-correlation function indicates a point of highest similarity and is used to determine the relative time shift between selected data pattern 206 and delayed digital RX signal 208.

Signal quality mapper 204 receives correlation signal 210, determines specific signal quality values that are associated with the specific instantaneous values of correlation signal 210 (i.e., “maps” correlation signal 210 with specific signal quality values), and outputs the determined signal quality values as the signal quality indication 212. In one or more examples, signal quality values may be predetermined and relationships between signal quality values and correlation signal 210 may be predetermined, and signal quality mapper 204 may include a Look-Up-Table that associates signal quality values with values of correlation signal 210. Alternatively, in one or more examples, an apparatus 200 may include a filter instead of signal quality mapper 204. Such a filter may output signal quality values based on correlation signal 210. In one or more examples, signal quality values of signal quality indication 212 may correspond to (e.g., be or have a predetermined relationship with, without limitation) signal-to-noise ratio.

In one or more examples, the look-up table of signal-quality mapper 204 may be populated off-line by simulation data, a machine-learning (ML) regression procedure, or both. By way of non-limiting example of a ML regression procedure: correlation-magnitude traces are collected across a wide span of channel conditions and paired with ground-truth quality metrics (e.g., SNR or BER) to form a training set. An ML model—such as an n^{th}-order polynomial fit, a gradient-boosted tree, or a shallow neural network—is trained to approximate the desired mapping f( ) and the trained function is then sampled at predetermined correlation-magnitude points to generate the discrete entries of the LUT. Alternatively, in one or more examples, signal-quality mapper 204 may dispense with the LUT entirely and implement the regression function directly at run time, evaluating the polynomial coefficients or executing the trained ML network (or other computational engine) on the instantaneous correlation value.

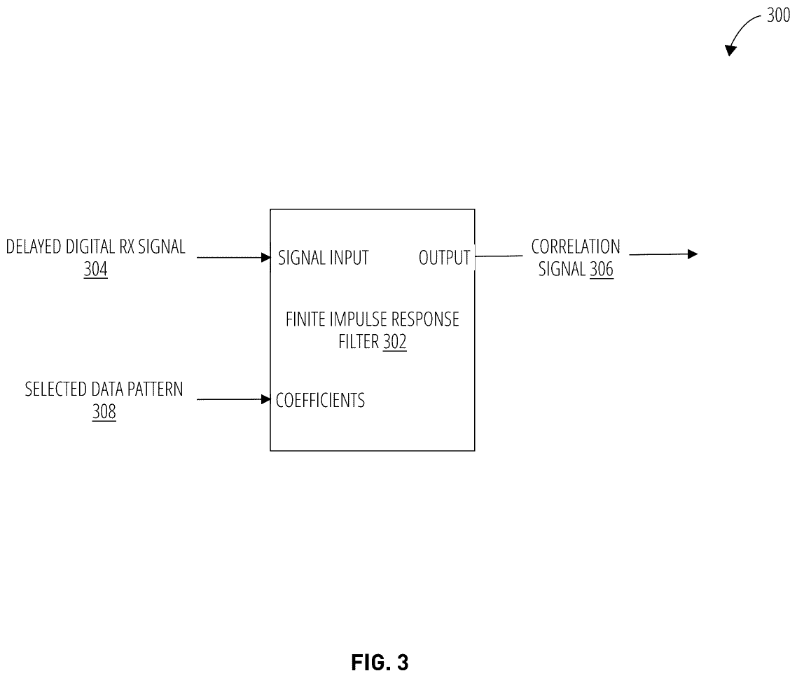

FIG. 3 is a block diagram of an apparatus 300 to correlate a digital RX signal with a selected pattern, in accordance with one or more examples. Apparatus 300 may be an example of correlator 202 of FIG. 2.

Apparatus 300 includes a finite impulse response (FIR) filter 302 to correlate delayed digital RX signal 304 with selected data pattern 308. In this example, the coefficients of FIR filter 302 are set at least partially based on selected data pattern 308. In one or more examples, the coefficients are set to be a time-reversed or conjugated version of selected data pattern 308. The coefficients define the impulse response of FIR filter 302. FIR filters 302 perform convolution of the delayed digital RX signal 304 with its filter response and output a result. The output (i.e., the convolution of delayed digital RX signal 304 with the filter response) is used as correlation signal 306, which correlation signal 306 may be an example of correlation signal 210 of FIG. 2.

In one or more examples, the number M of coefficients that define the impulse response of FIR filter 302 may be fixed (e.g., predetermined or determined once, without limitation) or adaptively varied in real-time. In the adaptively varied case, a control circuit (e.g., logic circuit 130 or an auxiliary adaptation engine) may estimate the instantaneous signal-to-noise ratio (SNR) from correlation signal 306 and-responsive to that estimate-select a longer coefficient set when SNR is high, or a shorter sliding-window coefficient set when SNR is low. Increasing M under favorable SNR conditions captures additional pattern energy and sharpens the correlation peak, whereas decreasing M under degraded SNR confines the operation to the most reliable samples and reduces noise folding. In one or more examples, the revised coefficient set may be obtained by truncating or zero-padding the time-reversed version of the selected data pattern 308, by interpolating between stored prototype tap sets, or by generating coefficients on-the-fly.

FIG. 4 is a block diagram of an apparatus 400 to detect the presence of scrambled data in a digital received signal, in accordance with one or more examples, and may be an example of a portion of logic circuit 130 of FIG. 1.

Apparatus 400 includes first pattern matcher 402 and second pattern matcher 404. First pattern matcher 402 detects a first predetermined data pattern associated with one or more symbols utilized to identify the start of scrambled data, and second pattern matcher 404 detects a second predetermined data pattern associated with one or more symbols utilized to identify the end of scrambled data. First pattern matcher 402 asserts first pattern indication 408 in response to the first predetermined data pattern associated with symbols utilized to identify the start of scrambled data in digital RX signal 406 being present (e.g., assert in response to detecting presence of the first predetermined data pattern, without limitation) and de-asserts first pattern indication 410 in response to the first predetermined pattern not being present (e.g., de-assert when it does not detect presence of the first predetermined data pattern, without limitation). Second pattern matcher 404 asserts second pattern indication 410 in response to the second predetermined data pattern associated with symbols utilized to identify the end of scrambled data in digital RX signal 406 being present (e.g., assert in response to detecting presence of the second predetermined data pattern, without limitation), and de-assert second pattern indication 410 in response to the second predetermined pattern not being present (e.g., de-assert when it does not detect presence of the second predetermined data pattern, without limitation). Additionally or alternatively to second pattern matcher 404, logic circuit 130 may include a bit or symbol counter to count a predetermined number of bits or symbols of digital RX signal 406 from the start of scrambled data indicated by first pattern indication 408. The predetermined number of bits or symbols may correspond to a known portion of a frame that may hold scrambled data. Thus, second pattern matcher 404 should be understood to be optional even though it is depicted in FIG. 4.

Digital RX signal 406 may be an example of digital RX signal 106 of FIG. 1. While two pattern matchers are depicted in FIG. 4, alternatively, a single pattern matcher may be used that asserts a pattern indication in response to detecting the first predetermined pattern and continues to assert the pattern indication, and de-asserts the pattern indication in response to detecting the second predetermined pattern.

In one or more examples, explicit scramble-state detection may be dispensed with (and so should be understood to be optional) entirely by, in the alternative, performing correlation against a plurality of candidate reference patterns in parallel. In such an arrangement, the digital RX signal 406 is applied concurrently to a bank of correlation engines (e.g., a set of FIR filters functionally similar to FIR filter 302 of FIG. 3) whose coefficient ports are pre-loaded with respectively different data patterns-including, for instance, the predetermined commit/beacon/SSD pattern, one or more recovered-data patterns, and any other protocol-specific symbol sequences of interest. A comparison circuit evaluates the absolute magnitudes of the simultaneously produced correlation signals and selects, for subsequent signal-quality computation, the reference pattern that yields the highest correlation score, optionally subject to a programmable threshold to avoid indeterminate selections. The strongest-correlating pattern is understood to be the one that is presently carried by the channel, this parallel-scoring technique obviates the first-and second-pattern matchers 402, 404 and the associated selection signal 132, thereby simplifying logic circuit 130 while still enabling real-time adaptation between scrambled and unscrambled portions of the frame.

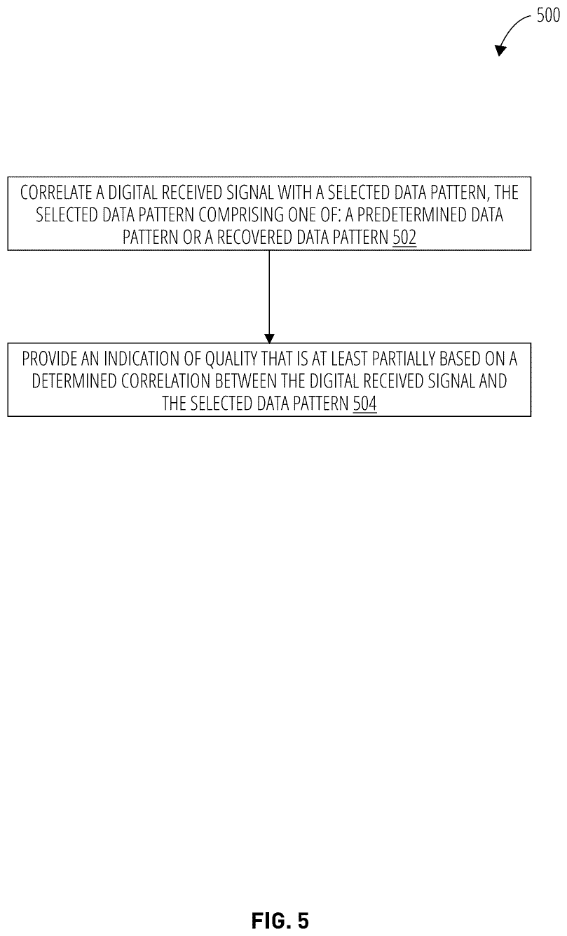

FIG. 5 illustrates an example process 500 for generating a signal quality indication in accordance with one or more examples. Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence. As a non-limiting example, some or a totality of operations of process 500 may be performed by apparatus 100, apparatus 200, apparatus 300, or apparatus 400.

According to one or more examples, the method includes correlating a digital received signal with a selected data pattern, the selected data pattern comprising one of: a predetermined data pattern or a recovered data pattern at operation 502.

According to one or more examples, the method includes providing an indication of quality that is at least partially based on a determined correlation between the digital received signal and the selected data pattern at operation 504.

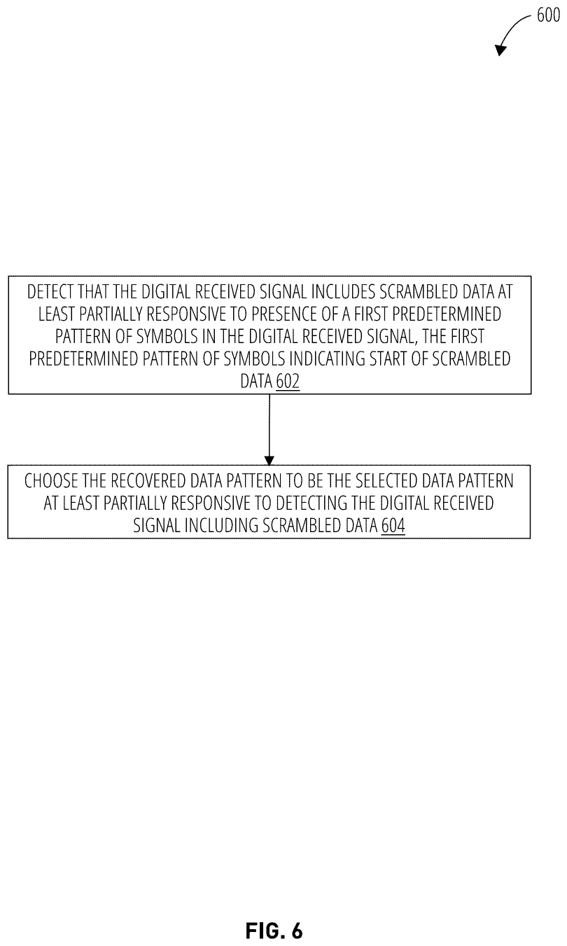

FIG. 6 illustrates an example process 600 for choosing a selected data pattern, in accordance with one or more examples. Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence. As a non-limiting example, some or a totality of operations of process 600 may be performed by apparatus 100 or apparatus 400.

According to one or more examples, the method includes detecting that the digital received signal includes scrambled data at least partially responsive to the presence of a first predetermined pattern of symbols in the digital received signal, the first predetermined pattern of symbols indicating start of scrambled data at operation 602. In one or more examples, the first predetermined pattern may correspond to symbols known to precede scrambled data in an Ethernet frame, such as symbols specified by IEEE 802.3cg, discussed above.

According to one or more examples, the method includes choosing the recovered data pattern to be the selected data pattern at least partially responsive to detecting the digital received signal including scrambled data at operation 604.

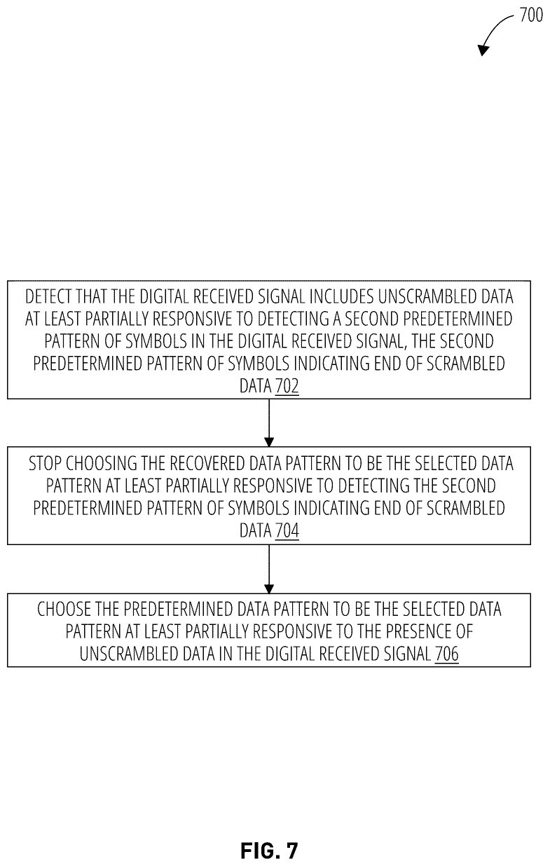

FIG. 7 illustrates an example process 700 for choosing a selected data pattern, in accordance with one or more examples. Although the example process 700 depicts a particular sequence of operations, the sequence may be altered without departing from the scope of the present disclosure. For example, some of the operations depicted may be performed in parallel or in a different sequence that does not materially affect the function of the process 700. In other examples, different components of an example device or system that implements the process 700 may perform functions at substantially the same time or in a specific sequence. As a non-limiting example, some or a totality of operations of process 700 may be performed by apparatus 100 or apparatus 400.

According to one or more examples, process 700 may include detecting that the digital received signal includes unscrambled data at least partially responsive to detecting a second predetermined pattern of symbols in the digital received signal, the second predetermined pattern of symbols indicating end of scrambled data at operation 702. In one or more examples, the second predetermined pattern may correspond to known, unscrambled symbols in an Ethernet frame, such as those specified by IEEE 802.3cg. In one or more examples, the first predetermined pattern (of operation 602, above) and the second predetermined pattern may be different. In one or more examples, one or both of the first predetermined pattern and the second predetermined pattern may be a predetermined number of bits from a known symbol. For example, unscrambled and scrambled portions of a frame may be known to have a fixed location relationship with each or with predetermined symbols. As a non-limiting example, unscrambled symbols and scrambled symbols may be a known number of bits from a predetermined pattern base of the frame structure. As noted above, IEEE 802.3cg specifies unscrambled commit, beacon and SSD symbols followed by the scrambled preamble and payload.

According to one or more examples, process 700 may include stop choosing the recovered data pattern to be the selected data pattern at least partially responsive to detecting the second predetermined pattern of symbols indicating end of scrambled data, at operation 704.

According to one or more examples, process 700 may include choosing the predetermined data pattern to be the selected data pattern at least partially responsive to the presence of unscrambled data in the digital received signal at operation 706.

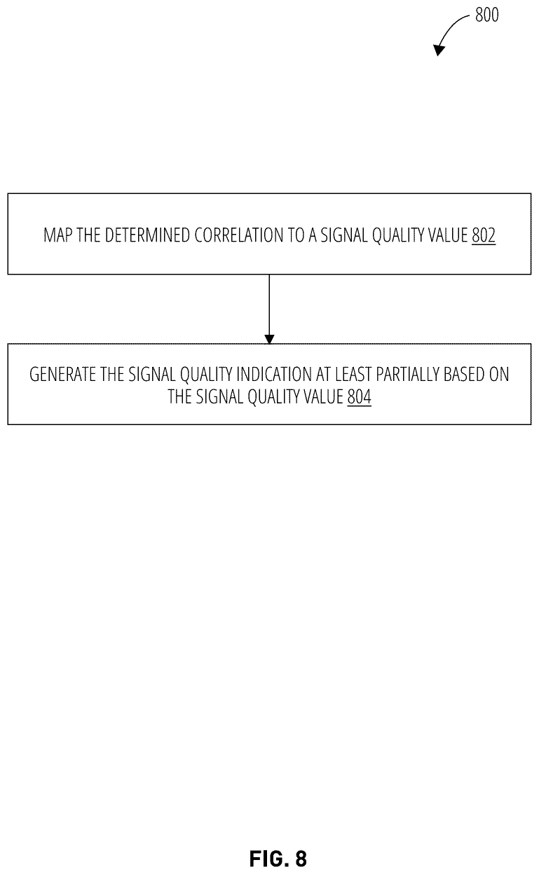

FIG. 8 illustrates an example process 800 for determining a signal quality based on a correlation, in accordance with one or more examples. Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence. As a non-limiting example, some or a totality of operations of process 800 may be performed by apparatus 100 or apparatus 200.

According to one or more examples, the method includes mapping the determined correlation to a signal quality value at operation 802.

According to one or more examples, the method includes generating the signal quality indication at least partially based on the signal quality value at operation 804.

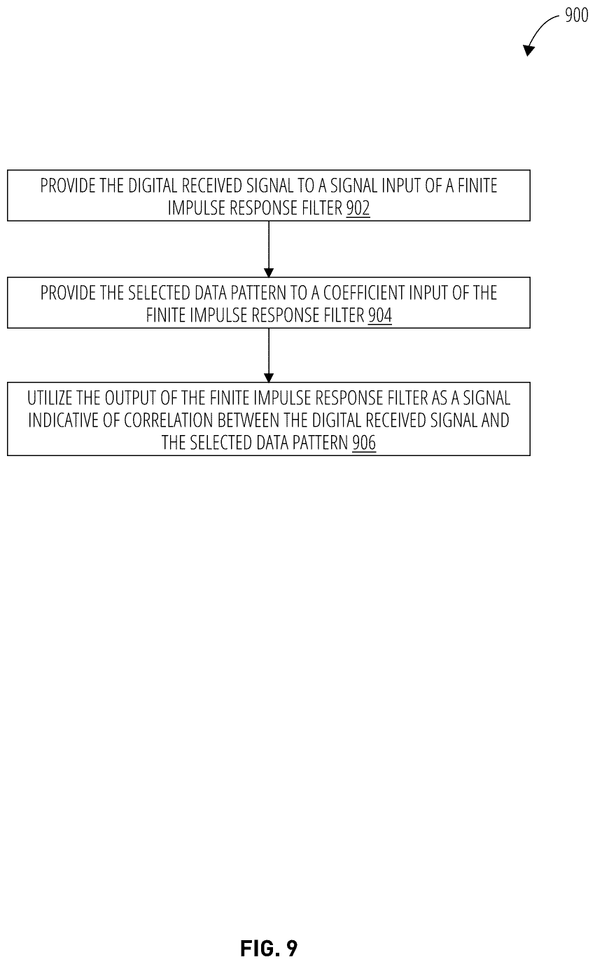

FIG. 9 illustrates an example process 900 for using an FIR filter to generate a correlation signal, in accordance with one or more examples. Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at substantially the same time or in a specific sequence. As a non-limiting example, some or a totality of operations of process 900 may be performed using apparatus 300.

According to one or more examples, the method includes providing the digital received signal to a signal input of a finite impulse response filter at operation 902.

According to one or more examples, the method includes providing the selected data pattern to a coefficient input of the finite impulse response filter at operation 904.

According to one or more examples, the method includes utilizing the output of the finite impulse response filter as a correlation signal indicative of correlation between the digital received signal and the selected data pattern at operation 906.

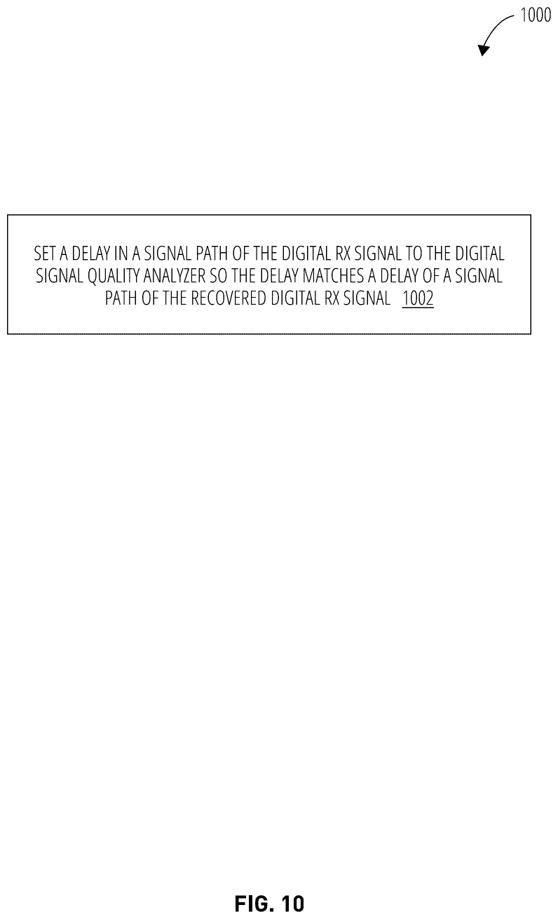

FIG. 10 illustrates an example process 1000 for reducing a timing mismatch between a selected data pattern and a digital received signal, in accordance with one or more examples. Although the example process 1000 depicts a particular sequence of operations, the sequence may be altered without departing from the scope of the present disclosure. For example, some of the operations depicted may be performed in parallel or in a different sequence that does not materially affect the function of the process 1000. In other examples, different components of an example device or system that implements the process 1000 may perform functions at substantially the same time or in a specific sequence. In one or more examples, some or a totality of operations of process 1000 may be performed by delay 108 of FIG. 1.

According to one or more examples, process 1000 may include setting a delay in a signal path of the digital RX signal (e.g., setting delay 108 of FIG. 1, without limitation) to the signal quality analyzer (e.g., signal quality analyzer 110 of FIG. 1) so the delay matches a delay of a signal path of the recovered digital RX signal (e.g., the path that provides the selected data pattern 122 to signal quality analyzer 110, without limitation) at operation 1002.

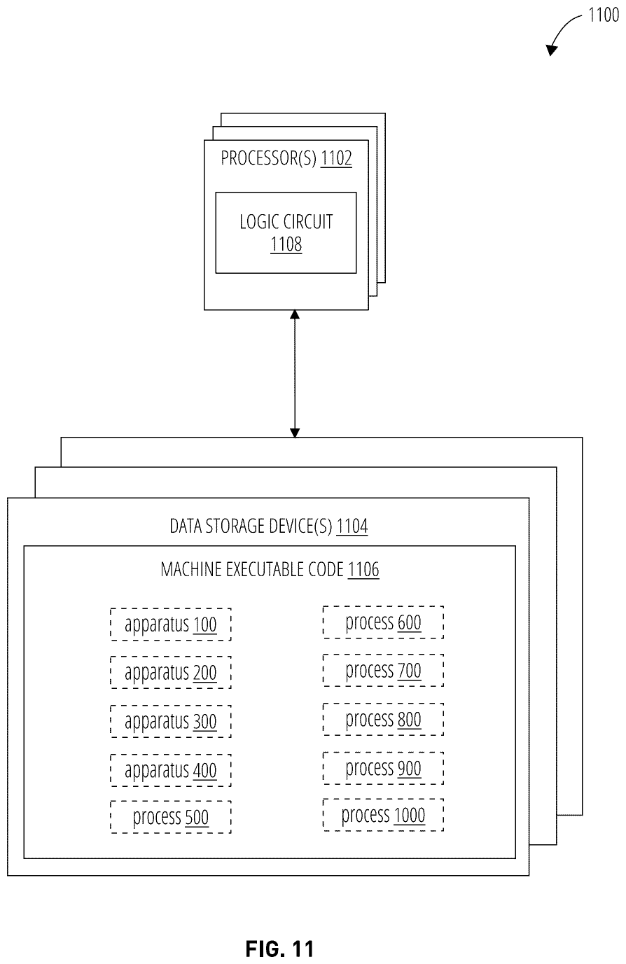

It will be appreciated by those of ordinary skill in the art that functional elements of examples disclosed herein (e.g., functions, operations, acts, processes, or methods) may be implemented in any suitable hardware, software, firmware, or combinations thereof. FIG. 11 illustrates non-limiting examples of implementations of functional elements disclosed herein. In some examples, some or all portions of the functional elements disclosed herein may be performed by hardware capable of carrying out the functional elements.

FIG. 11 is a block diagram of a circuitry 1100 that, in some examples, may be used to implement various functions, operations, acts, processes, or methods disclosed herein. The circuitry 1100 includes one or more processors 1102 (sometimes referred to herein as “processors 1102”) operably coupled to one or more data storage devices 1104 (sometimes referred to herein as “storage 1104”). The storage 1104 includes machine executable code 1106 stored thereon and the processors 1102 include logic circuit 1108. The machine executable code 1106 includes information describing functional elements that may be implemented by (e.g., performed by) the logic circuit 1108. The logic circuit 1108 is adapted to implement (e.g., perform) the functional elements described by the machine executable code 1106. The circuitry 1100, when executing the functional elements described by the machine executable code 1106, should be considered as special purpose hardware for carrying out functional elements disclosed herein. In some examples, the processors 1102 may perform the functional elements described by the machine executable code 1106 sequentially, concurrently (e.g., on one or more different hardware platforms), or in one or more parallel process streams.

When implemented by logic circuit 1108 of the processors 1102, the machine executable code 1106 adapts the processors 1102 to perform operations of examples disclosed herein. By way of non-limiting example, the machine executable code 1106 may adapt the processors 1102 to perform some or a totality of operations of one or more of: process 500, process 600, process 700, process 800, process 900, or process 1000.

Also by way of non-limiting example, the machine executable code 1106 may adapt the processors 1102 to perform some or a totality of features, functions, or operations disclosed herein for one or more of: apparatus 100, apparatus 200, apparatus 300, or apparatus 400. More specifically, features, functions, or operations disclosed herein for one or more of: sampler 104, delay 108, signal quality analyzer 110, decoder 112, memory 116, multiplexer 120, or logic circuit 130; correlator 202, or signal quality mapper 204; FIR filter 302; or first pattern matcher 402 or second pattern matcher 404.

The processors 1102 may include a general purpose processor, a special purpose processor, a central processing unit (CPU), a microcontroller, a programmable logic controller (PLC), a digital signal processor (DSP), an application-specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine executable code 1106 (e.g., software code, firmware code, hardware descriptions) related to examples of the present disclosure. It is noted that a general-purpose processor (may also be referred to herein as a host processor or simply a host) may be a microprocessor, but in the alternative, the processors 1102 may include any conventional processor, controller, microcontroller, or state machine. The processors 1102 may also be implemented as a combination of computing devices, such as a combination of a DSP and a microprocessor, a plurality of microprocessors, one or more microprocessors in conjunction with a DSP core, or any other such configuration.

In some examples, the storage 1104 includes volatile data storage (e.g., random-access memory (RAM)), non-volatile data storage (e.g., Flash memory, a hard disc drive, a solid state drive, erasable programmable read-only memory (EPROM), without limitation). In some examples, the processors 1102 and the storage 1104 may be implemented into a single device (e.g., a semiconductor device product, a system on chip (SOC), without limitation). In some examples, the processors 1102 and the storage 1104 may be implemented into separate devices.

In some examples the machine executable code 1106 may include computer-readable instructions (e.g., software code, firmware code). By way of non-limiting example, the computer-readable instructions may be stored by the storage 1104, accessed directly by the processors 1102, and executed by the processors 1102 using at least the logic circuit 1108. Also by way of non-limiting example, the computer-readable instructions may be stored on the storage 1104, transferred to a memory device (not shown) for execution, and executed by the processors 1102 using at least the logic circuit 1108. Accordingly, in some examples the logic circuit 1108 includes electrically configurable logic circuit 1108.

In some examples, the machine executable code 1106 may describe hardware (e.g., circuitry) to be implemented in the logic circuit 1108 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG, SYSTEMVERILOG or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1108 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the machine executable code 1106 may include an HDL, an RTL, a GL description, a mask level description, other hardware description, or any combination thereof.

In examples where the machine executable code 1106 includes a hardware description (at any level of abstraction), a system (not shown, but including the storage 1104) implements the hardware description described by the machine executable code 1106. By way of non-limiting example, the processors 1102 may include a programmable logic device (e.g., an FPGA or a PLC), and the logic circuit 1108 may be electrically controlled to implement circuitry corresponding to the hardware description into the logic circuit 1108. Also by way of non-limiting example, the logic circuit 1108 may include hard-wired logic manufactured by a manufacturing system (not shown, but including the storage 1104) according to the hardware description of the machine executable code 1106.

Regardless of whether the machine executable code 1106 includes computer-readable instructions or a hardware description, the logic circuit 1108 is adapted to perform the functional elements described by the machine executable code 1106 when implementing the functional elements of the machine executable code 1106. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: A method, comprising: correlating a digital received signal with a selected data pattern, the selected data pattern comprising one of: a predetermined data pattern or a recovered data pattern; and providing an indication of quality that is at least partially based on a determined correlation between the selected data pattern and the selected data pattern.

Example 2: The method according to Example 1, comprising: detecting that the digital received signal includes scrambled data at least partially responsive to detecting a first predetermined pattern of symbols in the digital received signal, the first predetermined pattern of symbols indicating start of scrambled data; and choosing the recovered data pattern to be the selected data pattern at least partially responsive to detecting the digital received signal including scrambled data.

Example 3: The method according to Examples 1 and 2, comprising: detecting that the digital received signal includes unscrambled data at least partially responsive to detecting a second predetermined pattern of symbols in the digital received signal, the second predetermined pattern of symbols indicating end of scrambled data; and choosing the predetermined data pattern to be the selected data pattern at least partially responsive to detecting the digital received signal including unscrambled data.

Example 4: The method according to any of Examples 1 to 3, comprising: mapping the determined correlation to a signal quality value; and generating the indication of signal quality at least partially based on the signal quality value.

Example 5: The method according to any of Examples 1 to 4, wherein correlating the digital received signal with the selected data pattern comprising: providing the digital received signal to a signal input of a finite impulse response filter; and providing the selected data pattern to a coefficient input of the finite impulse response filter; and utilizing the output of the finite impulse response filter as a correlation signal indicative of correlation between the digital received signal and the selected data pattern.

Example 6: The method according to any of Examples 1 to 5, wherein the correlating the digital received signal with the selected data pattern comprising: cross-correlating the digital received signal with the selected data pattern.

Example 7: The method according to any of Examples 1 to 6, comprising: identifying a timing misalignment between the digital received signal and the selected data pattern before correlating; and reducing the timing misalignment.

Example 8: An apparatus, comprising: a signal quality analyzer to generate an indication of signal quality that is at least partially based on a determined correlation between a digital received signal and a selected data pattern; and a logic circuit to choose one of a predetermined data pattern or a recovered data pattern to be the selected data pattern.

Example 9: The apparatus according to Example 8, wherein the signal quality analyzer comprises: a correlator to correlate the digital received signal with the selected data pattern; and a signal quality mapper to determine the indication of signal quality at least partially based on the determined correlation between the digital received signal and the selected data pattern.

Example 10: The apparatus according to Examples 8 and 9, comprising: a memory to store the predetermined data pattern; a decoder to generate the recovered data pattern based on the digital received signal; and a multiplexer having inputs coupled to respective ones of the memory and the decoder, the multiplexer to provide one of the predetermined data pattern or the recovered data pattern as the selected data pattern at least partially based on a selection signal, wherein the logic circuit to set the selection signal to choose one of the predetermined data pattern or the recovered data pattern to be the selected data pattern.

Example 11: The apparatus according to any of Examples 8 to 10, wherein the logic circuit to: choose the recovered data pattern to be the selected data pattern at least partially responsive to detecting presence of scrambled data in the digital received signal.

Example 12: The apparatus according to any of Examples 8 to 11, wherein the logic circuit to: detect the digital received signal includes unscrambled data at least partially responsive to detecting a first predetermined pattern of symbols in the digital received signal, the first predetermined pattern of symbols indicating start of scrambled data.

Example 13: The apparatus according to any of Examples 8 to 12, wherein the logic circuit to: choose the predetermined data pattern to be the selected data pattern at least partially responsive to detecting presence of unscrambled data in the digital received signal.

Example 14: The apparatus according to any of Examples 8 to 13, wherein the logic circuit to: detect that the digital received signal includes unscrambled data at least partially responsive to detecting a second predetermined pattern of symbols in the digital received signal, the second predetermined pattern of symbols indicating end of scrambled data; and

Example 15: The apparatus according to any of Examples 8 to 14, wherein the logic circuit to set the selection signal to a first value in response to detection of scrambled data and set the signal to a second value in response to detection of unscrambled data.

Example 16: The apparatus according to any of Examples 8 to 15, comprising: a delay circuit to set a timing of signal path of the digital RX signal to the signal quality analyzer to match a timing of signal path of the recovered digital RX signal to the signal quality analyzer.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the present disclosure as hereinafter claimed along with their legal equivalents. In addition, features from one example may be combined with features of another example while still being encompassed within the scope of the present disclosure.

What is claimed is:

1. A method, comprising:
correlating a digital received signal with a selected data pattern, the selected data pattern comprising one of: a predetermined data pattern or a recovered data pattern; and
providing an indication of quality that is at least partially based on a determined correlation between the digital received signal and the selected data pattern.

2. The method of claim 1, comprising:
detecting that the digital received signal includes scrambled data at least partially responsive to detecting a first predetermined pattern of symbols in the digital received signal, the first predetermined pattern of symbols indicating start of scrambled data; and
choosing the recovered data pattern to be the selected data pattern at least partially responsive to detecting the digital received signal including scrambled data.

3. The method of claim 1, comprising:
detecting that the digital received signal includes unscrambled data at least partially responsive to detecting a second predetermined pattern of symbols in the digital received signal, the second predetermined pattern of symbols indicating end of scrambled data; and
choosing the predetermined data pattern to be the selected data pattern at least partially responsive to detecting the digital received signal including unscrambled data.

4. The method of claim 1, comprising:
mapping the determined correlation to a signal quality value; and
generating the indication of signal quality at least partially based on the signal quality value.

5. The method of claim 1, wherein correlating the digital received signal with the selected data pattern comprising:
providing the digital received signal to a signal input of a finite impulse response filter; and
providing the selected data pattern to a coefficient input of the finite impulse response filter; and
utilizing an output of the finite impulse response filter as a correlation signal indicative of correlation between the digital received signal and the selected data pattern.

6. The method of claim 1, wherein the correlating the digital received signal with the selected data pattern comprising:
cross-correlating the digital received signal with the selected data pattern.

7. The method of claim 1, comprising:
identifying a timing misalignment between the digital received signal and the selected data pattern before correlating; and
reducing the timing misalignment.

8. An apparatus, comprising:
a signal quality analyzer to generate an indication of signal quality that is at least partially based on a determined correlation between a digital received signal and a selected data pattern; and
a logic circuit to choose one of a predetermined data pattern or a recovered data pattern to be the selected data pattern.

9. The apparatus of claim 8, wherein the signal quality analyzer comprises:
a correlator to correlate the digital received signal with the selected data pattern; and
a signal quality mapper to determine the indication of signal quality at least partially based on the determined correlation between the digital received signal and the selected data pattern.

10. The apparatus of claim 8, comprising:
a memory to store the predetermined data pattern;
a decoder to generate the recovered data pattern based on the digital received signal; and
a multiplexer having inputs coupled to respective ones of the memory and the decoder, the multiplexer to provide one of the predetermined data pattern or the recovered data pattern as the selected data pattern at least partially based on a selection signal,
wherein the logic circuit to set the selection signal to choose one of the predetermined data pattern or the recovered data pattern to be the selected data pattern.

11. The apparatus of claim 10, wherein the logic circuit to:
choose the recovered data pattern to be the selected data pattern at least partially responsive to detecting presence of scrambled data in the digital received signal.

12. The apparatus of claim 11, wherein the logic circuit to:
detect the digital received signal includes unscrambled data at least partially responsive to detecting a first predetermined pattern of symbols in the digital received signal, the first predetermined pattern of symbols indicating start of scrambled data.

13. The apparatus of claim 10, wherein the logic circuit to:
choose the predetermined data pattern to be the selected data pattern at least partially responsive to detecting presence of unscrambled data in the digital received signal.

14. The apparatus of claim 10, wherein the logic circuit to:
detect that the digital received signal includes unscrambled data at least partially responsive to detecting a second predetermined pattern of symbols in the digital received signal, the second predetermined pattern of symbols indicating end of scrambled data.

15. The apparatus of claim 10, wherein the logic circuit to set the selection signal to a first value in response to detection of scrambled data and set the signal to a second value in response to detection of unscrambled data.

16. The apparatus of claim 8, comprising:
a delay circuit to set a timing of signal path of the digital received signal to the signal quality analyzer to match a timing of signal path of the recovered data pattern to the signal quality analyzer.
